(19) United States
(12) Patent Application Publication
(10) Pub. No.: US 2026/0236820 A1
(43) Pub. Date: Aug. 13, 2026

(54) HYBRID QUANTUM-PROBABILISTIC ALGORITHMS FOR SAMPLING AND OPTIMIZATION

(71) Applicant: HEWLETT PACKARD ENTERPRISE DEVELOPMENT LP, Spring, TX (US)

(72) Inventors: Giacomo Pedretti, San Francisco, CA (US); Masoud Mohseni, Calabasas, CA (US); Raymond Gerard Beausoleil, Seattle, WA (US)

(21) Appl. No.: 19/286,408

(22) Filed: Jul. 31, 2025

Related U.S. Application Data
(60) Provisional application No. 63/721,363, filed on Nov. 15, 2024.

(51) Int. Cl. G06N 10/60; G06N 10/20

(52) U.S. Cl. CPC G06N 10/60; G06N 10/20

(57) ABSTRACT

Hybrid quantum and probabilistic methods for sampling and/or optimization problems may include using a probabilistic processing unit (PPU) to perform classical sampling for part of the problem space and using a quantum processing unit (QPU) to perform quantum sampling for another portion of the problem space. A method may include representing the problem as a graph; partitioning with sparsification the graph into subgraphs; performing classical sampling on a larger subgraph by the PPU; and performing quantum sampling on the smaller subgraph by the QPU. A method may include a non-equilibrium non-local Monte Carlo approach, including obtaining a seed solution; finding backbones or frozen variables in a configuration space; performing classical sampling on the backbones or frozen variables by the PPU, inducing a larger Hamming distance exploration; and providing coordinates from the classical sampling to the QPU and performing quantum sampling based on the coordinates, inducing a smaller Hamming distance exploration.

### CROSS REFERENCE TO RELATED APPLICATION

This application claims priority to U.S. Provisional Application No. 63/721,363, filed Nov. 15, 2024, which is incorporated by reference herein in its entirety.

### INTRODUCTION

Sampling and optimization workloads in artificial intelligence (AI), operational research, and computational science are typically characterized by heavy, NP-hard computations, such as sampling and optimization. An example of a workload characterized by such operations are an energy-based AI models and the Boolean Satisfiability optimization problem.

### BRIEF DESCRIPTION OF THE DRAWINGS

The present disclosure can be understood from the following detailed description, either alone or together with the accompanying drawings. The drawings are included to provide a further understanding of the present disclosure and are incorporated in and constitute a part of this specification. The drawings illustrate one or more examples of the present teachings and together with the description explain certain principles and operation. In the drawings:

FIG. 1 is a process flow diagram illustrating an example method.

FIG. 2 is a block diagram illustrating an example hybrid quantum probabilistic computer.

FIG. 3 is a block diagram illustrating an example non-transitory computer readable medium storing instructions.

FIG. 4 is a process flow diagram illustrating another example method.

FIG. 5 is a block diagram illustrating another example hybrid quantum probabilistic computer.

FIG. 6 is a block diagram illustrating another example non-transitory computer readable medium storing instructions.

### DETAILED DESCRIPTION

NP-hard optimization and sampling workloads, such as the Boolean Satisfiability optimization problem and training/inference of energy based models (EBMs), can be significantly accelerated by quantum computers (QCs). However, while providing high-quality solutions, currently available QCs have only a limited number of q-bits and are, in general, hard to scale up. Probabilistic computers (p-computers) have emerged as an alternative approach to execute high-performance sampling on classical digital hardware, such as field programmable gate arrays (FPGAs) or custom Application Specific Integrated Circuits (ASICs). Similarly to QCs, p-computers are hard to scale up, but the number of variables (probabilistic bits, or p-bits) that a single probabilistic processing unit (PPU) can integrate is significantly larger than the number of variables (quantum-bits or q-bits) that a single quantum processing unit (QPU) can accommodate. In particular, the scaling issue regards the full connectivity between variables, and typically architectures in which a variable is connected to only a subset of other variables are easier to build. However, when using a p-computer, the quality of the sampling operation and the degree to which the sampling can be sped up are limited compared to using QCs.

To address these and other issues, disclosed herein are hybrid quantum-probabilistic sampling and/or optimization techniques that combine aspects of probabilistic sampling and quantum sampling, effectively taking the best of each, resulting in a significant speed-up.

In one example heterogeneous sampling technique, a large graph is partitioned with sparsification techniques by 1) freezing a subset of variables, and 2) sampling over the rest of the variables, which represent a smaller and lower dimensional subgraph. Then a probabilistic processing unit (PPU) (e.g., p-computer) can be used to sample larger and denser subgraphs, whereas smaller subgraphs, which may be more quantum-prone, may be sampled by a quantum processing unit (QPU) (e.g., QC). The sampling performed by the p-computer may reveal boundary conditions for the sampling performed by the QCs.

Another example heterogeneous sampling technique may include non-equilibrium Monte Carlo sampling. First, a solution candidate is found. For example, an off-the-shelf (commercially available) solver may be used to generate a seed solution. Next, backbone or frozen variables that keep the solution anchored to the local minima may be found. The PPU (p-computer) may perform sampling on the resulting subgraph, inducing exploration at a relatively large hamming distance in the solution space. Then, the QPU (quantum computer) may perform sampling at a relatively low hamming distance for nonlocal exploration or shallower energy barriers that would be prone to quantum tunneling.

These techniques allow PPUs to be used for portions of the sampling where they excel, such as portions with more variables, while allowing QPUs to be used for portions of the sampling where they excel, such as in providing high-quality sampling for smaller variable regions. Thus, the overall speed, efficiency, and quality with which the sampling and optimization problem are solved can be greatly increased.

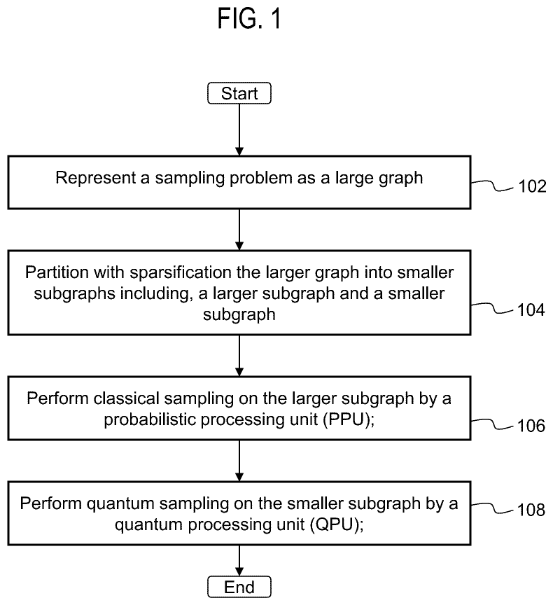

Turning now to FIG. 1, a method 100 will be described. The method 100 is a method of processing (e.g., solving) a sampling and/or optimization problem or workload by a hybrid quantum and probabilistic algorithm.

Step 102 comprises representing the sampling problem as a large graph. Classical and quantum sampling and optimization consist in finding low-energy states representing optimal or near-optimal solutions of the Hamiltonian

$$H = {\sum }_{i j} {J}_{i j} {s}_{i} {s}_{j} + {\sum }_{i} {h}_{i} {s}_{i}$$

where Jᵢⱼ is the coupling strength between nodes i and j, and hᵢ is an external field acting on node i. The problem may be represented as a graph, with i and j being nodes of the graph and Jᵢⱼ being an edge extending between nodes i and j.

However, for many sampling problems, the resulting graphs are too large to fit either in QPUs or PPUs. Thus, Step 104 comprises partitioning with sparsification the graph into smaller subgraphs. In other words, the large graph is broken down into small subgraphs to fit quantum and probabilistic accelerators (the QPU and PPU). The subgraphs from the partitioning may include at least one larger subgraph and at least one smaller subgraph. The partitioning may comprise: 1) freezing a subset of variables, and 2) sampling over the rest of the variables, which represent a smaller and lower dimensional subgraph.

Step 106 comprises performing classical sampling on the larger (denser) subgraph by a PPU. As mentioned above, sampling generally comprises finding low-energy states of H, such as through gradient descent. The energy landscape defined by H can include local minima, and while performing gradient descent the sampling algorithm may get stuck in such a local minimum. This minimum may not represent the best solution, which may be the global minimum, and so the sampling algorithm needs ways to discover that it is in a local minimum and escape it. Classical sampling uses thermal fluctuations to help the system escape local minima, essentially performing random moves not necessary in the direction of the gradient. PPUs are well suited to this classical sampling, as their p-bits have a random nature that lends itself well to modeling the thermal fluctuations. In addition, PPUs can handle larger number of variables than QPUs (i.e., PPUs tend to have more p-bits than QPUs have q-bits), making the PPU well suited to sampling the larger subgraph. Moreover, the sampling performed by the PPU may reveal boundary conditions for subsequent quantum sampling (see step 108, described below).

Step 108 comprises performing quantum sampling on the smaller subgraph by a QPU. Quantum sampling via QPUs use techniques such as quantum tunneling through energy barriers to the escape from local minimum, even ones bounded by very steep energy barriers. The sampling performed by the PPU may reveal boundary conditions for the sampling performed by the QPU, and the QPU may thus sample based on these boundary conditions. The QPU can handle fewer variables and thus is better suited for the smaller subgraphs. Moreover, the smaller subgraphs may be more quantum-prone, again making sampling by the QPU appropriate.

By partitioning the graph into smaller subgraphs using both the PPU to sample the larger subgraph and the QPU to sample the smaller subgraph, the strengths of both PPUs and QPUs can be brought to bear, allowing for highly efficient sampling.

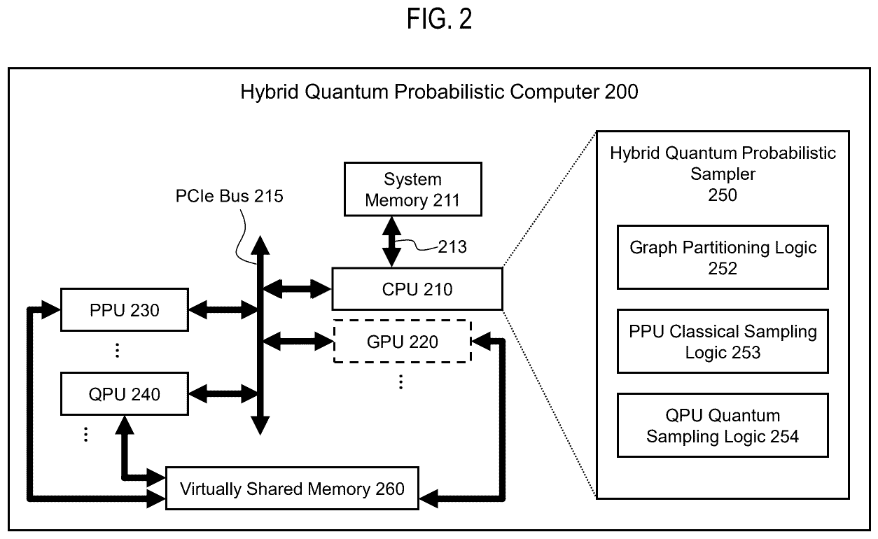

Turning now to FIG. 2, a hybrid quantum probabilistic computer 200 (“computer 200”) will be described. It should be understood that FIG. 2 is not intended to illustrate specific shapes, dimensions, positional relationships, or other structural details accurately or to scale, and that implementations of the heterogeneous probabilistic computer 200 may have different numbers and arrangements of the illustrated components and may also include other parts that are not illustrated.

The computer 200 comprises a CPU 210 and a system memory 211 connected to the CPU 210 by memory interface 213. In some examples, system memory 211 is dynamic random access memory (DRAM). In other examples, the system memory 211 may be another type of memory, such as high bandwidth memory (HBM). The memory interface 213 may be a double data rate (DDR) interface, which may include any generation of DDR (e.g., DDR, DDR-2, DDR-3, DDR-4, DDR-4, etc.), or any other type of memory interface appropriate for the type of memory being used.

The computer 200 also comprises one or more PPUs 230 (only one is illustrated in FIG. 2, but more could be present in some examples). The PPU 230 may be formed, in some examples, from a field programmable gate array (FPGA).

The computer 200 also comprises one or more QPUs 240 (only one is illustrated in FIG. 2, but more could be present in some examples). The QPUs 240 may comprise a collection of physically embodied qubits (a physical QPU) or it may be simulated using classical hardware (a simulated QPU). The QPUs 240 may be analog (e.g., based on quantum annealing) or digital (e.g., based on Quantum Approximation Optimization Algorithm (QAOA).

In some examples, the computer 200 also comprises a GPU 220, which would make the computer 200 a heterogeneous probabilistic computer 200. In some examples, the GPU 220 may be an integrated GPU that is part of the same system-on-chip (SoC) as the CPU 210. In some examples, the GPU 220 may be an expansion card that is communicably coupled to the CPU 210 via an expansion slot. In some examples GPU 220 may be omitted.

The computer 200 also comprises a communication bus 215 that is communicably connected to each of the CPU 210, GPU 220, PPU 230, and QPU 240. The bus 215 may include any type of computer communication bus, and in some examples may include a bus that can allow for peer-to-peer communication between components. Peer-to-peer communication, in this context, refers to communication that can be exchanged directly between two components in the computer 200 without having to pass through the CPU 210. An example of a communication bus that can be used as the bus 215 is a peripheral component interconnect express (PCIe) bus.

The computer 200 also comprises a hybrid quantum probabilistic sampler 250 (“sampler 250”). The sampler 250 comprises graph partitioning logic 252, PPU classical sampling logic 253, and QPU quantum sampling logic 254. The logic 252, 253, and 254 may comprise instructions stored in a non-transitory computer readable medium and executable by the CPU 210, PPU 230, and/or QPU 240 to cause operations described herein to be performed, dedicated hardware configured to perform operations described herein, or some combination of these. In examples where logic 252, 253, and 254 comprises instructions stored in a non-transitory computer readable medium, the sampler 250 may be instantiated by the CPU 210, PPU 230, and/or QPU 240 executing these instructions.

The sampler 250 is configured to process or solve a sampling and/or optimization problem or workload by a hybrid quantum and probabilistic algorithm. In particular, sampler 250 is configured to perform operations of the method 100. An example of a sampling and/or optimization problem or workload that the sampler 250 may process is an energy based model (EBM). EBMs define probability distributions over data by associating an “energy” value with each possible state of the data. They aim to model the relationship between observed data and hidden representations by minimizing energy for observed patterns and maximizing it for unobserved patterns. For example, Boltzmann Machines (BM) are a type of EBM composed of visible (input) and hidden units arranged in a fully connected, symmetric network. BMs use an energy function that assigns low energy to configurations that correspond to likely patterns. BMs are trained using gradient-based methods, but convergence can be slow due to complex connections and dependencies between units. Restricted BMs are a simplified version of BMs with a bipartite structure (visible and hidden units are connected, but units within the same layer are not). The restricted BMs may be faster and easier to train than standard BMs using contrastive divergence, as the bipartite structure eliminates the need for inter-layer dependencies.

The sampler 250 may be configured to process or solve the sampling and/or optimization problem or workload by using (e.g., executing instructions associated with) the logic 251, 252, and 253, as will be described in more detail below.

The graph partitioning logic 252 causes CPU 210 or another processor (e.g., PPU 230) to represent a sampling problem as a graph and the partition that graph into subgraphs. Specifically, logic 252 causes the processor to perform steps 102 and 104 of method 100.

The PPU classical sampling logic 253 causes the PPU 230 to perform classical sampling on a larger subgraph of the partitioned subgraphs. Specifically, logic 253 causes the processor to perform steps 106 of method 100.

The QPU quantum sampling logic 254 causes the QPU 240 to perform classical sampling on a smaller subgraph of the partitioned subgraphs. Specifically, logic 254 causes the processor to perform steps 108 of method 100.

In some examples, CPU 210 and/or GPU 220 may also perform computations based on the sampling performed by the PPU 230 and QPU 240. For example, gradients, weights, biases, and/or other values may be computed based on one iteration of sampling, and these values may be fed back to the PPU 230 and QPU 240 to facilitate a next iteration of sampling. In examples where GPU 220 is included, the GPU 220 may perform the computation of the gradients, weights, biases, and/or other values as it may be optimized for such computations. In some examples, peer-to-peer communications may be used between the PPU 230, QPU 240, and/or GPU 220 to facilitate faster and more efficient processing.

The computer 200 also comprises virtual shared memory 260 communicably connected to the PPU 230, QPU 240, and the GPU 220 (if present). The virtually shared memory 260 comprises one more memory devices (e.g., DRAM) that are accessible to the PPUs 230, QPUs 240, and/or GPUs 220 and thus appear as if they were a single memory. The memory 260 is only “virtually” shared, however, as it in reality may comprise separate memory devices that may be specific to the GPUs 220, QPUs 240, and/or PPUs 230. For instance, GPU 220 may have GPU memory (e.g., dynamic random access memory (DRAM), graphics double data rate (DDR) synchronous DRAM (GDDR SDRAM), synchronous graphics RAM (SGRAM), high bandwidth memory (HBM), etc.), the PPU 230 may have PPU memory (e.g., DRAM), and/or the QPU 240 may have its own memory (e.g., DRAM), and each of these memories may collectively constitute the virtual shared memory 260. These memory devices, although separate, are described herein as being virtually shared because, in some examples, the peer-to-peer communication via bus 215 allows any of the PPUs 230, QPUs 240, and/or GPUs 220 to access the data stored in the memories of any of the other components without going through the CPU 210 or the system memory 211, and thus the memories of the GPUs 220 can be effectively considered as being a single virtually “shared” memory.

In FIG. 2, the PPU 230 and QPU 240 are shown as part of the same computer 200 and are connected together by a bus 215. However, this is just one example of how a PPU and QPU which are used in performing the method of FIG. 1 could be configured. In other examples, the PPU and QPU could be part of larger computing system with distributed nodes (such as a high performance compute (HPC) system), but the PPU and QPU are not necessarily part of the same node or blade and may be communicably connected by a network rather than a local PCIe bus. In still other examples, the PPU and QPU are parts of wholly separate computer systems that communicate over a network.

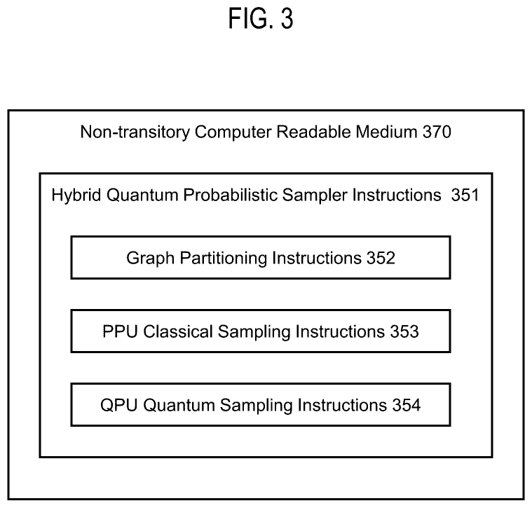

Turning to FIG. 3, an example non-transitory computer readable medium 370 will be described. The medium 370 may be any data storage device (or multiple such devices) that is non-transitory, such as a hard drive, solid state drive, flash media, optical disk, magnetic storage media, etc. The medium 370 stores hybrid quantum probabilistic sampler instructions 351, which are executable by a processor (e.g., of a CPU, PPU, QPU, and/or GPU) to instantiate a hybrid quantum probabilistic sampler, such as the sampler 150 described above.

The instructions 351 include graph partitioning instructions 352. These instructions 352 are executable by a processor to cause the processor to perform operations corresponding to steps 102 and 104 of method 100. In other words, instructions 352 are one example implementation of logic 152.

The instructions 351 include PPU classical sampling instructions 353. These instructions 353 are executable by a processor to cause the processor to perform operations corresponding to step 106 of method 100. In other words, instructions 353 are one example implementation of logic 153.

The instructions 351 include QPU quantum sampling instructions 354. These instructions 354 are executable by a processor to cause the processor to perform operations corresponding to step 108 of method 100. In other words, instructions 354 are one example implementation of logic 154.

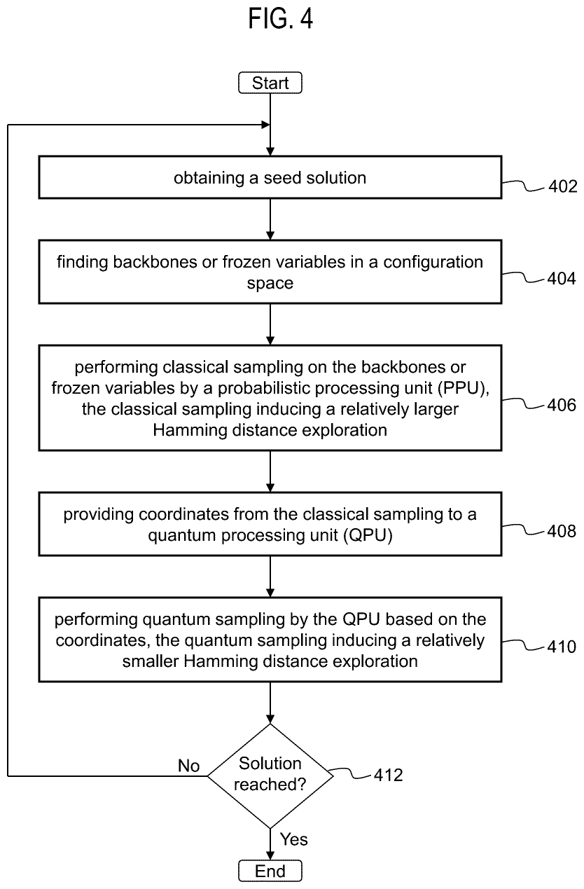

Turning now to FIG. 4, a method 400 will be described. The method 400 is another method of processing (e.g., solving) a sampling and/or optimization problem or workload by a hybrid quantum and probabilistic algorithm. In particular, the method 400 comprises a hybrid quantum and probabilistic version of a non-equilibrium Monte Carlo sampling.

Step 402 comprises finding a solution candidate. For example, an off-the-shelf (commercially available) solver, such a Boolean satisfiability problem (SAT) solver in the case of a SAT problem, or an Ising Machine in the case of a quadratic unconstrained binary optimization (QUBO) problem, may be used to generate a seed solution.

Step 404 comprises finding backbone or frozen variables that keep the solution anchored to the local minima. These backbone frozen variables may be found in the configuration space near a phase transition (e.g., for k-SAT problems near a computational SAT/UNSAT phase transition). In particular, backbones with a high degree of connectivity may be identified.

Step 406 comprises using the PPU (p-computer) to perform classical sampling on the resulting subgraph (formed from the backbones), inducing exploration at a relatively large hamming distance in the solution space.

Step 408 comprises providing the new coordinates found from the PPU's classical sampling to the QPU. For example, in some implementations in which QPU and PPU are both part of the same heterogeneous probabilistic computer, peer-to-peer communications may be used to forward the coordinates from PPU to QPU.

Step 410 comprises using the QPU (quantum computer) to perform sampling based on the new coordinates, inducing nonlocal exploration at a relatively low hamming distance over regions with significant entropic barriers or shallower energy barriers that would be prone to quantum tunneling on the QPU.

Step 412 comprises determining whether a solution has been reached. If so (yes), the method 400 may end. If not (no), the method may loop back to step 402 for another iteration of the method.

This hybrid quantum classical sampling technique can enhance diffusion in configuration and improve quality and diversity of solutions given a time or energy budget, as new basins of attraction could be found orders of magnitude faster and more energy efficiently than using either probabilistic accelerators or quantum accelerators alone.

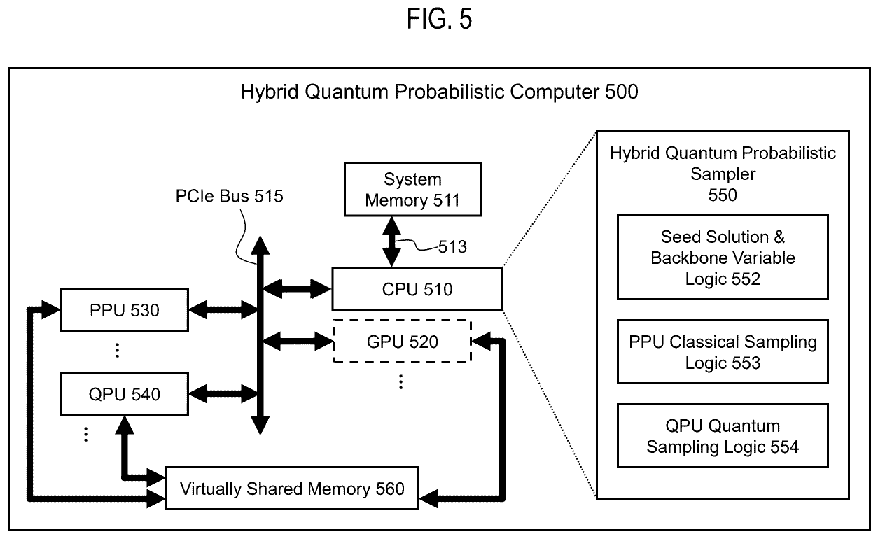

Turning now to FIG. 5, a hybrid quantum probabilistic computer 500 (“computer 500”) will be described. It should be understood that FIG. 5 is not intended to illustrate specific shapes, dimensions, positional relationships, or other structural details accurately or to scale, and that implementations of the heterogenous probabilistic computer 500 may have different numbers and arrangements of the illustrated components and may also include other parts that are not illustrated.

The computer 500 comprises a CPU 510 and a system memory 511 connected to the CPU 510 by memory interface 513. In some examples, system memory 511 is dynamic random access memory (DRAM). In other examples, the system memory 511 may be another type of memory, such as high bandwidth memory (HBM). The memory interface 513 may be a double data rate (DDR) interface, which may include any generation of DDR (e.g., DDR, DDR-2, DDR-3, DDR-4, DDR-4, etc.), or any other type of memory interface appropriate for the type of memory being used.

The computer 500 also comprises one or more PPUs 530 (only one is illustrated in FIG. 5, but more could be present in some examples). The PPU 530 may be formed, in some examples, from a field programmable gate array (FPGA).

The computer 500 also comprises one or more QPUs 540 (only one is illustrated in FIG. 5, but more could be present in some examples). The QPUs 540 may comprise a collection of physically embodied qubits (a physical QPU) or it may be simulated using classical hardware (a simulated QPU). The QPUs 540 may be analog (e.g., based on quantum annealing) or digital (e.g., based on Quantum Approximation Optimization Algorithm (QAOA).

In some examples, the computer 500 also comprises a GPU 520, which would make the computer 500 a heterogenous probabilistic computer 500. In some examples, the GPU 520 may be an integrated GPU that is part of the same system-on-chip (SoC) as the CPU 510. In some examples, the GPU 520 may be an expansion card that is communicably coupled to the CPU 510 via an expansion slot. In some examples GPU 520 may be omitted.

The computer 500 also comprises a communication bus 515 that is communicably connected to each of the CPU 510, GPU 520, PPU 530, and QPU 540. The bus 515 may include any type of computer communication bus, and in some examples may include a bus that can allow for peer-to-peer communication between components. Peer-to-peer communication, in this context, refers to communication that can be exchanged directly between two components in the computer 500 without having to pass through the CPU 510. An example of a communication bus that can be used as the bus 515 is a peripheral component interconnect express (PCIe) bus.

The computer 500 also comprises a hybrid quantum probabilistic sampler 550 (“sampler 550”). The sampler 550 comprises seed solution & Backbone variable logic 552, PPU classical sampling logic 553, and QPU quantum sampling logic 554. The logic 552, 553, and 554 may comprise instructions stored in a non-transitory computer readable medium and executable by the CPU 510, PPU 530, and/or QPU 540 to cause operations described herein to be performed, dedicated hardware configured to perform operations described herein, or some combination of these. In examples where logic 552, 553, and 554 comprises instructions stored in a non-transitory computer readable medium, the sampler 550 may be instantiated by the CPU 510, PPU 530, and/or QPU 540 executing these instructions.

The sampler 550 is configured to process or solve a sampling and/or optimization problem or workload by a hybrid quantum and probabilistic non-equilibrium Monte Carlo algorithm. In particular, sampler 550 is configured to perform operations of the method 400. An example of a sampling and/or optimization problem or workload that the sampler 550 may process is an energy based model (EBM).

The sampler 550 may be configured to process or solve the sampling and/or optimization problem or workload by using (e.g., executing instructions associated with) the logic 551, 552, and 553, as will be described in more detail below.

The seed solution & backbone variable logic 552 causes CPU 510 or another processor (e.g., PPU 530) to obtain a seed solution and find background or frozen variables in the configuration space of the seed solution. Specifically, logic 552 causes the processor to perform steps 402 and 404 of method 100.

The PPU classical sampling logic 553 causes the PPU 530 to perform classical sampling on the backbone or frozen variables. Specifically, logic 553 causes the processor to perform steps 406 and 408 of method 100.

The QPU quantum sampling logic 554 causes the QPU 540 to perform classical sampling on coordinates passed to it from the PPU. Specifically, logic 554 causes the processor to perform step 410 of method 100.

In some examples, CPU 510 and/or GPU 520 may also perform computations based on the sampling performed by the PPU 530 and QPU 540. For example, gradients, weights, biases, and/or other values may be computed based on one iteration of sampling, and these values may be fed back to the PPU 530 and QPU 540 to facilitate a next iteration of sampling. In examples where GPU 520 is included, the GPU 520 may perform the computation of the gradients, weights, biases, and/or other values as it may be optimized for such computations. In some examples, peer-to-peer communications may be used between the PPU 530, QPU 540, and/or GPU 520 to facilitate faster and more efficient processing.

The computer 500 also comprises virtual shared memory 560 communicably connected to the PPU 530, QPU 540, and the GPU 520 (if present). The virtually shared memory 560 comprises one more memory devices that are accessible to the PPUs 530, QPUs 540, and/or GPUs 520 and thus appear as if they were a single memory, similar to the memory 260 described above.

In FIG. 5, the PPU 530 and QPU 540 are shown as part of the same computer 500 and are connected together by a bus 515. However, this is just one example of how a PPU and QPU which are used in performing the method of FIG. 1 could be configured. In other examples, the PPU and QPU could be part of larger computing system with distributed nodes (such as a high performance compute (HPC) system), but the PPU and QPU are not necessarily part of the same node or blade and may be communicably connected by a network rather than a local PCIe bus. In still other examples, the PPU and QPU are parts of wholly separate computer systems that communicate over a network.

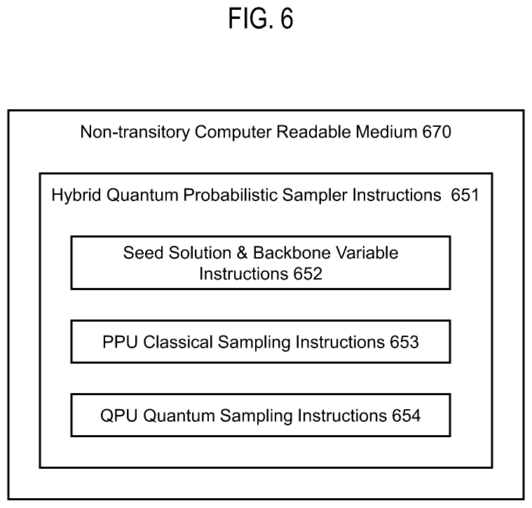

Turning to FIG. 6, an example non-transitory computer readable medium 670 will be described. The medium 670 may be any data storage device (or multiple such devices) that is non-transitory, such as a hard drive, solid state drive, flash media, optical disk, magnetic storage media, etc. The medium 670 stores hybrid quantum probabilistic sampler instructions 651, which are executable by a processor (e.g., of a CPU, PPU, QPU, and/or GPU) to instantiate a hybrid quantum probabilistic sampler, such as the sampler 550 described above.

The instructions 651 include seed solution & backbone variable instructions 652. These instructions 652 are executable by a processor to cause the processor to perform operations corresponding to steps 402 and 404 of method 400. In other words, instructions 652 are one example implementation of logic 552.

The instructions 651 include PPU classical sampling instructions 653. These instructions 653 are executable by a processor to cause the processor to perform operations corresponding to steps 406 and 408 of method 400. In other words, instructions 653 are one example implementation of logic 553.

The instructions 651 include QPU quantum sampling instructions 654. These instructions 654 are executable by a processor to cause the processor to perform operations corresponding to step 410 of method 400. In other words, instructions 654 are one example implementation of logic 554.

It is to be understood that both the general description and the detailed description provide examples that are explanatory in nature and are intended to provide an understanding of the present disclosure without limiting the scope of the present disclosure. Various mechanical, compositional, structural, electronic, and operational changes may be made without departing from the scope of this description and the claims. In some instances, well-known circuits, structures, and techniques have not been shown or described in detail in order not to obscure the examples. Like numbers in two or more figures represent the same or similar elements.

In addition, the singular forms “a”, “an”, and “the” are intended to include the plural forms as well, unless the context indicates otherwise. Moreover, the terms “comprises”, “comprising”, “includes”, and the like specify the presence of stated features, steps, operations, elements, and/or components but do not preclude the presence or addition of one or more other features, steps, operations, elements, components, and/or groups. Components described as connected may be electronically or mechanically directly connected, or they may be indirectly connected via one or more intermediate components, unless specifically noted otherwise. Mathematical and geometric terms are not necessarily intended to be used in accordance with their strict definitions unless the context of the description indicates otherwise, because a person having ordinary skill in the art would understand that, for example, a substantially similar element that regions in a substantially similar way could easily fall within the scope of a descriptive term even though the term also has a strict definition.

And/or: Occasionally the phrase “and/or” is used herein in conjunction with a list of items. This phrase means that any combination of items in the list—from a single item to all of the items and any permutation in between—may be included. Thus, for example, “A, B, and/or C” means “one of {A}, {B}, {C}, {A, B}, {A, C}, {C, B}, and {A, C, B}”.

Elements and their associated aspects that are described in detail with reference to one example may, whenever practical, be included in other examples in which they are not specifically shown or described. For example, if an element is described in detail with reference to one example and is not described with reference to a second example, the element may nevertheless be claimed as included in the second example.

Unless otherwise noted herein or implied by the context, when terms of approximation such as “substantially,” “approximately,” “about,” “around,” “roughly,” and the like, are used, this should be understood as meaning that mathematical exactitude is not required and that instead a range of variation is being referred to that includes but is not strictly limited to the stated value, property, or relationship. In particular, in addition to any ranges explicitly stated herein (if any), the range of variation implied by the usage of such a term of approximation includes at least any inconsequential variations and also those variations that are typical in the relevant art for the type of item in question due to manufacturing or other tolerances. In any case, the range of variation may include at least values that are within ±1% of the stated value, property, or relationship unless indicated otherwise.

Further modifications and alternative examples will be apparent to those of ordinary skill in the art in view of the disclosure herein. For example, the devices and methods may include additional components or steps that were omitted from the diagrams and description for clarity of operation. Accordingly, this description is to be construed as illustrative only and is for the purpose of teaching those skilled in the art the general manner of carrying out the present teachings. It is to be understood that the various examples shown and described herein are to be taken as exemplary. Elements and materials, and arrangements of those elements and materials, may be substituted for those illustrated and described herein, parts and processes may be reversed, and certain features of the present teachings may be utilized independently, all as would be apparent to one skilled in the art after having the benefit of the description herein. Changes may be made in the elements described herein without departing from the scope of the present teachings and following claims.

It is to be understood that the particular examples set forth herein are non-limiting, and modifications to structure, dimensions, materials, and methodologies may be made without departing from the scope of the present teachings.

Other examples in accordance with the present disclosure will be apparent to those skilled in the art from consideration of the specification and practice of the invention disclosed herein. It is intended that the specification and examples be considered as exemplary only, with the following claims being entitled to their fullest breadth, including equivalents, under the applicable law.

What is claimed is:

1. A method of processing a sampling and/or optimization problem by a hybrid quantum and probabilistic algorithm, comprising:
representing the problem as a graph;
partitioning with sparsification the graph into subgraphs including a larger subgraph and a smaller subgraph;
performing classical sampling on the larger subgraph by a probabilistic processing unit (PPU); and
performing quantum sampling on the smaller subgraph by a quantum processing unit (QPU).

2. The method of claim 1,
wherein performing classical sampling on the larger subgraph by the PPU generates boundary conditions for the sampling of the smaller subgraph by the QPU, and
wherein the method further comprises sending the boundary conditions from the PPU to the QPU and the performing the quantum sampling on the smaller subgraph by the QPU is based on the boundary conditions.

3. The method of claim 1, wherein partitioning with sparsification the graph into subgraphs comprises freezing a subset of variables out of a set of variables representative of the graph, with remaining unfrozen variables of the set representing the subgraphs.

4. The method of claim 1, wherein the sampling and/or optimization problem comprises an energy-based model.

5. The method of claim 1, wherein the PPU and the QPU are part of a heterogeneous probabilistic computer comprising the PPU, the QPU, a central processing unit (CPU), a graphics processing unit (GPU), and a bus communicably connecting the PPU, CPU, GPU and QPU.

6. The method of claim 5, further comprising communicating peer-to-peer between the PPU and the QPU via the bus without involvement of the CPU.

7. The method of claim 5, further comprising computing gradients, weights, and/or biases by the GPU based on the classical sampling of the PPU and the classical sampling of the QPU.

8. A non-transitory computer readable medium storing instructions executable by a processor of a heterogeneous probabilistic computer to instantiate a hybrid quantum probabilistic sampler configured to process a sampling and/or optimization problem by performing the method of claim 1.

9. A heterogeneous probabilistic computer, comprising:
a probabilistic processing unit (PPU);
a central processing unit (CPU);
a graphics processing unit (GPU);
a quantum processing unit (QPU);
a bus communicably connecting the PPU, CPU, GPU, and QPU; and
a non-transitory computer readable medium storing instructions executable by the CPU, PPU, and/or GPU to instantiate a hybrid quantum probabilistic sampler configured to process a sampling and/or optimization problem by performing the method of claim 1.

10. A method of processing a sampling and/or optimization problem by a hybrid quantum and probabilistic non-equilibrium non-local Monte Carlo algorithm, comprising:
obtaining a seed solution;
finding backbones or frozen variables in a configuration space;
performing classical sampling on the backbones or frozen variables by a probabilistic processing unit (PPU), the classical sampling inducing a relatively larger Hamming distance exploration; and
providing coordinates from the classical sampling to a quantum processing unit (QPU) and performing quantum sampling based on the coordinates, the quantum sampling inducing a relatively smaller Hamming distance exploration.

11. The method of claim 10, wherein the quantum sampling induces the relatively smaller Hamming distance exploration over regions with significant entropic barriers or shallow energy barriers prone to quantum tunneling on the QPU.

12. The method of claim 10, wherein obtaining the seed solution comprises using a commercially available solver to obtain the seed solution.

13. The method of claim 10, wherein the backbones or frozen variables are in a configuration space near a phase transition.

14. The method of claim 10, wherein the sampling and/or optimization problem comprises an energy-based model.

15. The method of claim 10, wherein the PPU and the QPU are part of a heterogeneous probabilistic computer comprising the PPU, the QPU, a central processing unit (CPU), a graphics processing unit (GPU), and a bus communicably connecting the PPU, CPU, GPU and QPU.

16. The method of claim 15, further comprising communicating peer-to-peer between the PPU and the QPU via the bus without involvement of the CPU.

17. The method of claim 15, further comprising computing gradients, weights, and/or biases by the GPU based on the classical sampling of the PPU and the classical sampling of the QPU.

18. A non-transitory computer readable medium storing instructions executable by a processor of a heterogeneous probabilistic computer to instantiate a hybrid quantum probabilistic sampler configured to process a sampling and/or optimization problem by performing the method of claim 10.

19. A heterogenous probabilistic computer, comprising:
a probabilistic processing unit (PPU);
a central processing unit (CPU);
a graphics processing unit (GPU);
a quantum processing unit (QPU);
a bus communicably connecting the PPU, CPU, GPU, and QPU; and
a non-transitory computer readable medium storing instructions executable by the CPU, PPU, and/or GPU to instantiate a hybrid quantum probabilistic sampler configured to process a sampling and/or optimization problem by performing the method of claim 10.

20. A heterogenous probabilistic computer, comprising:
a probabilistic processing unit (PPU);
a central processing unit (CPU);
a graphics processing unit (GPU);
a bus communicably connecting the PPU, CPU, and GPU;
a non-transitory computer readable medium storing instructions executable by the CPU, PPU, and/or GPU to instantiate a hybrid quantum probabilistic sampler configured to process a sampling and/or optimization problem by a hybrid quantum and probabilistic approach comprising:
executing a first hybrid quantum and probabilistic sampling method comprising:
representing the problem as a graph;
partitioning with sparsification a graph into subgraphs including a larger subgraph and a smaller subgraph;
performing classical sampling on the larger subgraph by a probabilistic processing unit (PPU); and
performing quantum sampling on the smaller subgraph by a
quantum processing unit (QPU); or executing a second hybrid quantum and probabilistic method sampling comprising:
obtaining a seed solution;
finding backbones or frozen variables in a configuration space;
performing classical sampling on the backbones or frozen variables by a probabilistic processing unit (PPU), the classical sampling inducing a relatively larger Hamming distance exploration; and
providing coordinates from the classical sampling to a quantum processing unit (QPU) and performing quantum sampling based on the coordinates, the quantum sampling inducing a relatively smaller Hamming distance exploration.
